(19) United States
(12) Patent Application Publication
(10) Pub. No.: US 2010/0077129 A1
(43) Pub. Date: Mar. 25, 2010

(54) Data Processing Apparatus, Data Processing Method and Recording Medium

(75) Inventor: Hideaki OGATA, Yokohama-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/556,393

(22) Filed: Sep. 9, 2009

(30) Foreign Application Priority Data
Sep. 19, 2008 (JP) 2008-240696

(51) Int. Cl. G06F 12/00

(52) U.S. Cl. 711/100; 711/E12.001

(57) ABSTRACT

A data processing apparatus includes a connection interface that performs connection to removable memories, and a dividing unit that divides original data into N pieces of subdata (N denotes an integer of 2 or more). The dividing unit stores one to (N−1) pieces of different subdata respectively in L removable memories (L denotes an integer in a range of 1 to N), which are connected to the connection interface.

### BACKGROUND

1. Technical Field

The present invention relates to a data processing apparatus, a data processing method and a recording medium.

2. Related Art

According to the related art, encryption using a passcode has been used to protect data. Further, a technology of performing encryption by dividing data has been generally known in the art (see JP-A-2004-234371, JP-A-2006-113663, JP-A-2006-12192 and JP-A-2005-99910).

However, in order to encrypt data, an apparatus for processing the data may be overloaded. Further, in order to reliably protect data, the configuration of a system for processing the data may be complicated.

### SUMMARY

An advantage of some aspects of the invention is to provide a technology capable of simplifying the configuration necessary for data protection.

### First Example

According to a first aspect of the invention, there is provided a data processing apparatus including a connection interface that performs connection to removable memories, and a dividing unit that divides original data into N pieces of subdata (N denotes an integer of 2 or more). The dividing unit stores one to (N−1) pieces of different subdata in L removable memories (L denotes an integer in a range of 1 to N), which are each connected to the connection interface.

The data processing apparatus having the above configuration, one to (N−1) pieces of different subdata is each stored in the L removable memories, so that the original data can be protected and the configuration which is necessary for data protection can be simplified.

### Second Example

In the data processing apparatus according to First Example, the data processing apparatus further includes a memory device fixed to the data processing apparatus. The total number of the subdata stored in the L removable memories is smaller than N. The dividing unit stores at least one piece of subdata, which corresponds to a remainder obtained by subtracting the subdata stored in the L removable memories from the N pieces of subdata, in the memory device, and divides the original data such that the total size of the subdata stored in one removable memory is smaller than the total size of the subdata stored in the memory device, in relation to the L removable memories.

According to the above-described data processing apparatus, the capacities of the removable memories, which are necessary for storing the subdata, can be prevented from becoming excessively large. Thus, the configuration which is necessary for data protection can be simplified.

### Third Example

In the data processing apparatus according to First Example or Second Example, in relation to each of the subdata stored in the removable memories, the dividing unit stores the whole portion of one subdata in the removable memory, without simultaneously maintaining the whole portion of the one subdata in the data processing apparatus.

According to the above-described data processing apparatus, the whole portion of one subdata is stored in the removable memory, without being simultaneously maintained in the data processing apparatus, so that the configuration which is necessary for data protection can be simplified while the data protection is being reliably performed.

### Fourth Example

In the data processing apparatus according to any one of First Example to Third Example, the dividing unit allows a user to determine a data division method.

According to the above-described data processing apparatus, in the case of using a division method determined by a user, the configuration which is necessary for data protection can be simplified.

### Fifth Example

In the data processing apparatus according to any one of First Example to Fourth Example, the dividing unit performs division and storage of the original data in response to a write request for the original data.

According to the above-described data processing apparatus, in the case of performing the division of the original data and the storage of the subdata in response to the write request for the original data, the configuration which is necessary for data protection can be simplified.

### Sixth Example

In the data processing apparatus according to Fifth Example, in relation to a plurality of memory areas used for storing the N pieces of subdata, the dividing unit regards a plurality of memory areas including the L removable memories as one virtual memory area. The original data is written on the one virtual memory area in response to the write request for the original data.

According to the above-described data processing apparatus, the configuration for the write request can be simplified.

### Seventh Example

In the data processing apparatus according to any one of First Example to Sixth Example, the data processing apparatus further includes a decoding unit that decodes the original data by using the N pieces of subdata including the subdata stored in the removable memories.

According to the above-described data processing apparatus, the configuration which is necessary for the protection and use of the data can be simplified.

### Eighth Example

According to a second aspect of the invention, there is provided a data processing method. In the data processing method, original data is divided into N pieces of subdata (N denotes an integer of 2 or more), and one to (N−1) pieces of different subdata is each stored in L removable memories (L denotes an integer in a range of 1 to N).

### Ninth Example

According to a third aspect of the invention, there is provided a computer-readable recording medium for recording a computer program that prompts a computer to execute functions of dividing original data into N pieces of subdata (N denotes an integer of 2 or more), and storing each of one to (N−1) pieces of different subdata in L removable memories (L denotes an integer in a range of 1 to N).

The invention can be realized in various ways. For example, the invention can be realized in the form of data processing method and apparatus, a computer program for realizing the method and functions of the apparatus, a recording medium for recording the computer program, and the like.

### BRIEF DESCRIPTION OF THE DRAWINGS

The invention will be described with reference to the accompanying drawings, wherein like numbers reference like elements.

FIG. 1 is a block diagram showing a data processing system according to one embodiment of the invention.

FIG. 2 is a block diagram showing functions of a data processing apparatus.

FIG. 3 is a view showing a write process.

FIG. 4 is a view showing data division.

FIG. 5 is a view showing a read process.

FIG. 6 is a view showing data division according to another embodiment.

FIG. 7 is a view showing a setting screen of a division module shown in FIG. 2.

FIG. 8 is a block diagram showing functions of a data processing apparatus according to another embodiment of the invention.

FIG. 9 is a block diagram showing a data processing system according to another embodiment.

FIG. 10 is a block diagram showing functions of a data processing system.

FIG. 11 is a block diagram showing functions of a data processing system according to another embodiment.

### DESCRIPTION OF EXEMPLARY EMBODIMENTS

The invention will be described in the following sequence.
A. First Embodiment
B. Second Embodiment
C. Third Embodiment
D. Fourth Embodiment
E. Fifth Embodiment
F. Sixth Embodiment
G. Modifications

### A. First Embodiment

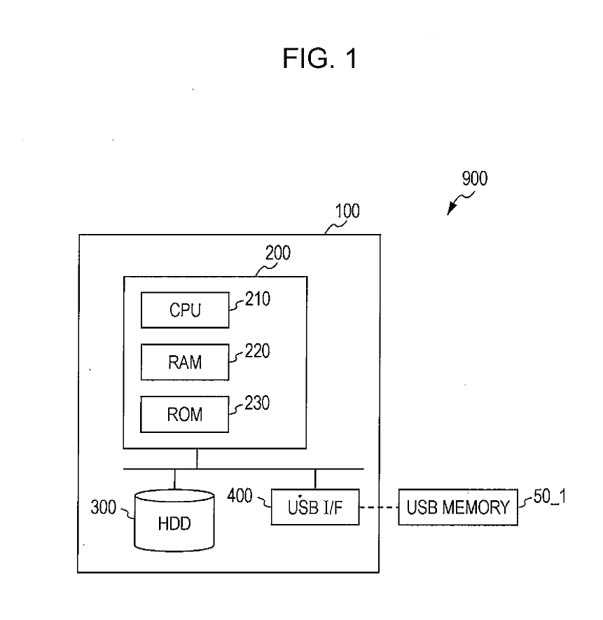

FIG. 1 is a block diagram showing a data processing system 900 according to one embodiment of the invention. The data processing system 900 includes a data processing apparatus 100 and a USB memory 50_1. The data processing apparatus 100 is a computer including a controller 200, a hard disk drive 300 and a USB interface 400. The controller 200 controls elements of the data processing apparatus 100, and includes a CPU 210, an RAM 220 and an ROM 230. The controller 200 is connected to the hard disk drive 300 and the USB interface 400 through a bus. Although not shown in FIG. 1, the data processing apparatus 100 is connected to a display device such as a liquid crystal display, an input device such as a mouse and a keyboard, and the like. The controller 200 displays various pieces of information on the display device and receives instructions from a user through the input device.

Various types of USB devices can be connected to the USB interface 400. According to the present embodiment, the USB memory 50_1 is connected to the USB interface 400. The USB memory 50_1 corresponds to a removable memory in the appended claims.

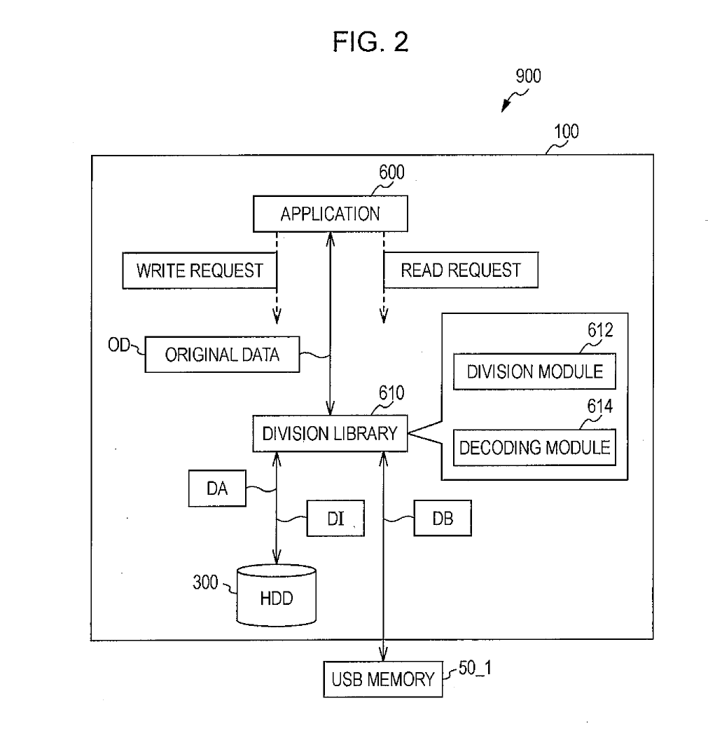

FIG. 2 is a block diagram showing functions of the data processing apparatus 100. An application 600 and a division library 610 correspond to programs (program modules). The division library 610 includes a division module 612 and a decoding module 614. The program modules 600 and 610 (612 and 614) are executed by the CPU 210 shown in FIG. 1. Execution of processing by the CPU 210 according to the program modules represents that the module executes processing. The program modules 600 and 610 (612 and 614) can transmit and receive data to and from each other through the RAM 220. Further, the program modules may be installed in the data processing apparatus 100 by a user through a recording medium such as a CD-ROM and a DVD-ROM, or a network. Furthermore, the program modules may be installed in advance in the data processing apparatus 100. The installed modules are stored in a memory device such as the hard disk drive 300, the RAM 220 and the ROM 230. According to the embodiment, the modules 600 and 610 are executed under the control of a predetermined operating system.

The application 600 is an application program of executing various types of data processing such as image processing and document creating. The application 600 executes data processing according to the instructions of a user. Further, the application 600 provides the division library 610 with a data write request and a data read request.

The division library 610 performs data read and write operations at the request of the application 600. According to the embodiment, the division library 610 performs the data read and data write operations by using the hard disk drive 300 and the USB memory 50_1.

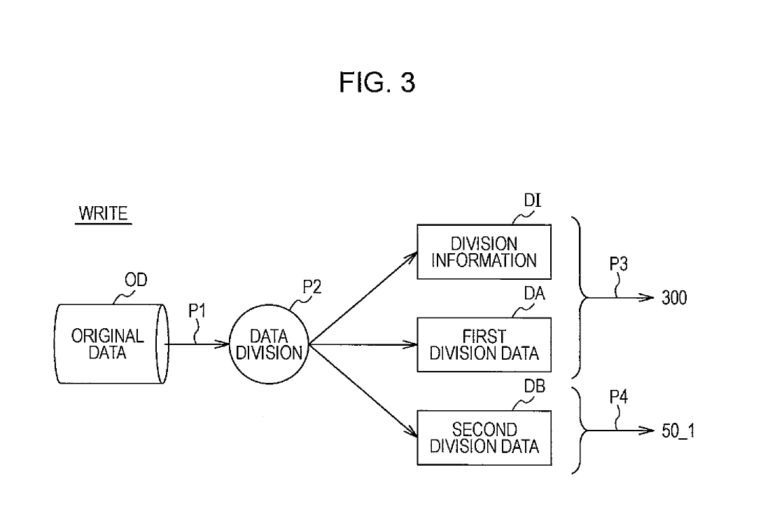

FIG. 3 is a view showing a write process, which shows a case in which the application 600 shown in FIG. 2 requests write of original data OD. The application 600 provides the division library 610 with a write request for the original data OD (Process P1). The original data OD is provided to the division library 610 through the RAM 220. The division module 612 divides the original data OD into two pieces of subdata DA and DB based on the write request (Process P2).

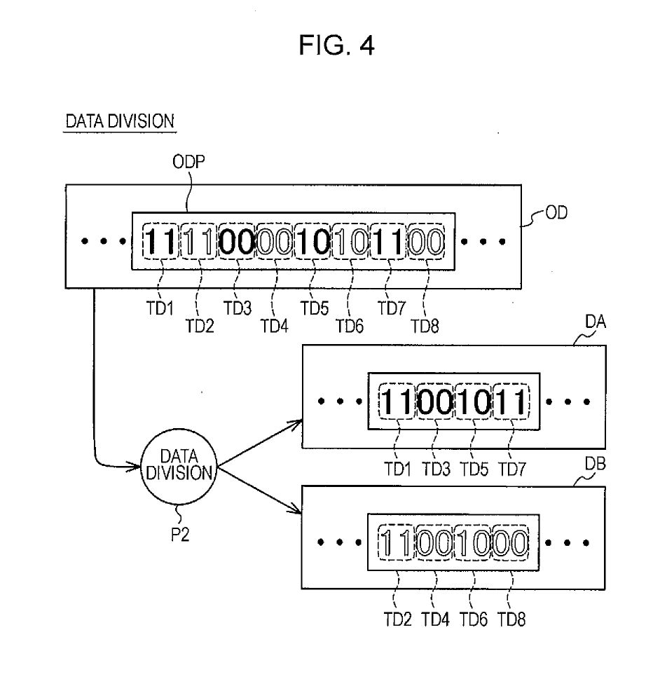

FIG. 4 is a view showing data division. According to the embodiment, the division module 612 shown in FIG. 2 subdivides a bit sequence representing the original data OD into a plurality of segments. According to the embodiment, one segment represents consecutive two bits of the original data OD. Further, the division module 612 collects segments in odd sequences to generate the first subdata DA and collects segments in even sequences to generate the second subdata DB. For example, in FIG. 4, 16 bit data block ODP included in the original data OD is divided into eight segments TD1 to TD8 (data is arranged in sequence of TD1 to TD8). The segments TD1, TD3, TD5 and TD7 in odd sequences are allocated to the first subdata DA and the segments TD2, TD4, TD6 and TD8 in even sequences are allocated to the second subdata DB. The order of the segments in the first subdata DA and the second subdata DB is equal to the order in the original data OD. For example, in the first subdata DA, the segments are arranged in sequence of TD1, TD3, TD5 and TD7. In the second subdata DB, the segments are arranged in sequence of TD2, TD4, TD6 and TD8.

The division module 612 shown in FIG. 2 stores the first subdata DA in the hard disk drive 300 shown in FIG. 2 (Process P3 in FIG. 3). Further, the division module 612 stores the second subdata DB in the USB memory 50_1 shown in FIG. 2 (Process P4 in FIG. 3). Further, the division module 612 stores information (hereinafter, referred to as division information DI) on the division in the hard disk drive 300. The division information DI stores information necessary for decoding the original data OD from the subdata DA and the subdata DB. For example, the division information DI includes the data file name of the original data OD, the storage position of the first subdata DA in the hard disk drive 300, and the storage position of the second subdata DB in the USB memory 50_1.

After the subdata DA and the subdata DB is completely stored, the division module 612 shown in FIG. 2 deletes the original data OD, which is received from the application 600, from the RAM 220 shown in FIG. 1. Further, a user may separate the USB memory 50_1 from the data processing apparatus 100. After a user completes the application 600, only the first subdata DA remains in the data processing apparatus 100. Meanwhile, only the second subdata DB is stored in the USB memory 50_1. Thus, even if only one of the data processing apparatus 100 and the USB memory 50_1 is used, only a part of the original data OD is obtained, so that the original data OD can be protected from unintended users.

Furthermore, the division module 612 stores the whole portion of the second subdata DB in the USB memory 50_1, without simultaneously maintaining the whole portion of the second subdata DB in the data processing apparatus 100. That is, the whole portion of the second subdata DB can be prevented from simultaneously existing in the memory device fixed to the data processing apparatus 100 due to the processing of the division module 612, so that the original data OD can be reliably protected. However, the division module 612 may simultaneously maintain the whole portion of the second subdata DB in the data processing apparatus 100.

Further, the memory device fixed to the data processing apparatus 100 is not a memory device (e.g., the USB memory 50_1) temporarily connected to the data processing apparatus 100, but a memory device (e.g., the hard disk drive 300 or the RAM 220) provided in the data processing apparatus 100 that cannot be separated from the data processing apparatus 100. Hereinafter, the memory device fixed to the data processing apparatus 100 will be referred to as a fixed memory device.

The whole portion of the second subdata DB can be stored in the USB memory 50_1 in various ways, without simultaneously maintaining the whole portion of the second subdata DB in the data processing apparatus 100. For example, the division module 612 repeats the following processes PA and PB.
(PA) obtaining a part of the second subdata DB from the original data OD
(PB) storing the obtained data in the USB memory 50_1 before obtaining the remaining part of the second subdata DB from the original data OD

Preferably, the division module 612 directly stores the primarily obtained data in the USB memory 50_1 without storing the part of the data, which is obtained through the process PA, in the fixed memory device. However, the division module 612 may temporarily store the part of the data, which is obtained through the process PA, in the fixed memory device. In such a case, the division module 612 deletes at least a part of the data temporarily stored in the fixed memory device before obtaining the whole portion of the second subdata DB from the original data OD.

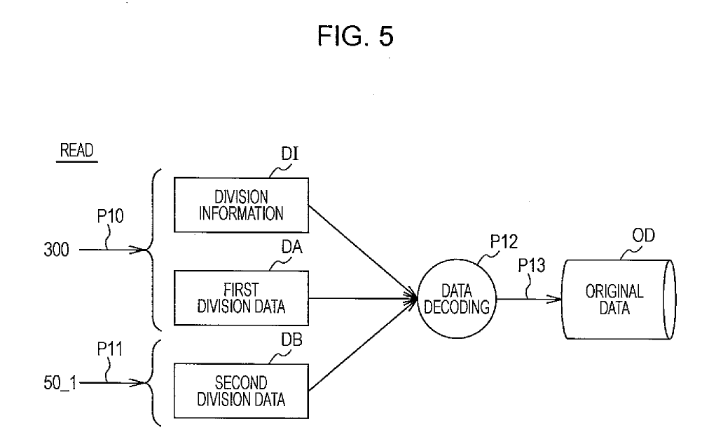

FIG. 5 is a view showing a read process, which shows a case in which the application 600 shown in FIG. 2 requests read of the original data OD which has been previously written. The application 600 provides the division library 610 with a read request for the original data OD. In relation to the read request, data to be read may be arbitrarily specified (in the embodiment of FIG. 5, the original data OD). For example, the application 600 may specify the data to be read by using a data file name.

After the read request is received, the decoding module 614 shown in FIG. 2 reads the division information DI, which corresponds to the data to be read, from the hard disk drive 300. The decoding module 614 reads the first subdata DA from the hard disk drive 300 (Process P10 in FIG. 5) and reads the second subdata DB from the USB memory 50_1 based on the division information DI (Process P11). Further, the decoding module 614 decodes the original data OD by using the first subdata DA and the second subdata DB (Process P12). The data is decoded in a sequence which is inverse to the data division sequence (see FIG. 4). The decoding module 614 provides the application 600 with the generated original data OD (Process P13).

Further, in a case in which the USB memory 50_1 is not connected to the data processing apparatus 100, the decoding module 614 may not obtain the second subdata DB. Thus, the decoding module 614 may not decode the original data OD.

According to the first embodiment as described above, the original data OD is divided into the two pieces of subdata DA and DB, and the subdata DB is stored in the USB memory 50_1, so that the original data OD can be protected. Further, the data protection is performed without using complicated encryption, so that the configuration of the apparatus can be simplified. Further, the data protection can be performed using the data processing apparatus 100 having a low processing ability. In addition, the data protection can be performed using the data processing apparatus 100 having a simple configuration, that is, the data processing apparatus 100 includes the USB interface 400. According to the first embodiment as described above, the configuration which is necessary for the data protection can be simplified. Further, the division library 610 can be commonly used for a plurality of applications.

### B. Second Embodiment

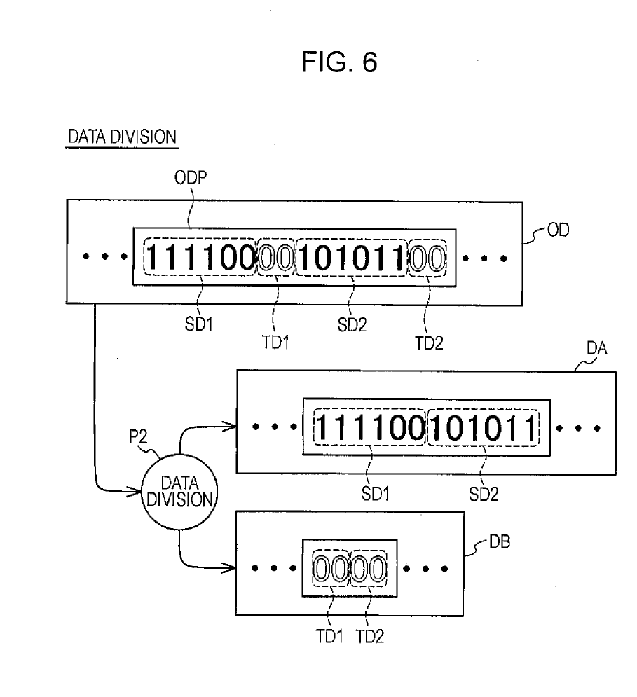

FIG. 6 is a view showing data division according to another embodiment. The present embodiment shown in FIG. 6 is substantially identical to the embodiment shown in FIG. 4, except that a 6 bit segment is allocated to the first subdata DA instead of the 2 bit segment. The configuration of a system used for the data division is substantially identical to the data processing system 900 shown in FIGS. 1 and 2.

The division module 612 shown in FIG. 2 divides the bit sequence representing the original data OD into a plurality of 6 bit segments and a plurality of 2 bit segments such that the 6 bit segments are aligned alternately with the 2 bit segments. Further, the division module 612 collects the 6 bit segments to generate the first subdata DA and collects the 2 bit segments to generate the second subdata DB. For example, referring to FIG. 6, the 16 bit data block ODP included in the original data OD is divided into two 6 bit segments SD1 and SD2 and two 2 bit segments TD1 and TD2, and the data is arranged in sequence of SD1, TD1, SD2 and TD2. The 6 bit segments SD1 and SD2 are allocated to the first subdata DA and the 2 bit segments TD1 and TD2 are allocated to the second subdata DB.

As a result, the size of the second subdata DB is smaller than the size of the first subdata DA. Thus, the capacity of the USB memory 50_1, which is necessary for data protection, can be prevented from becoming excessively large. Consequently, in the case of protecting the original data OD having a large size, the simple USB memory 50_1 can be used, so that the configuration which is necessary for data protection can be simplified.

### C. Third Embodiment

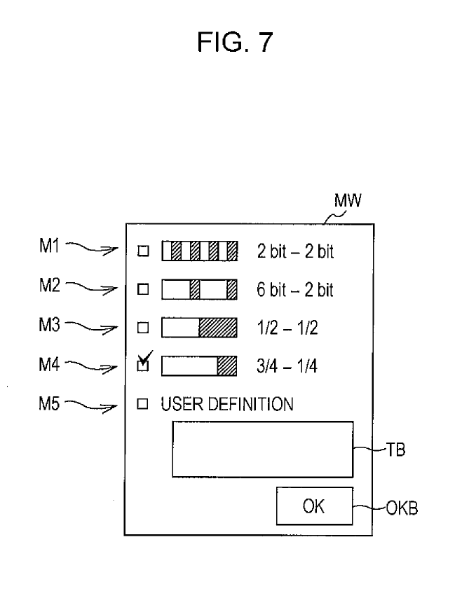

FIG. 7 is a view showing a setting screen MW of the division module 612 shown in FIG. 2. A user can designate a division method through the setting screen MW. The division module 612 displays the setting screen MW on a display device (not shown) according to the instructions of a user. As described above, the division module 612 allows a user to determine a division method. In the previous embodiments, a user can determine the division method.

According to the embodiment shown in FIG. 7, a user can select one of five selection items M1 to M5.
(1) the first selection item M1 is equal to the division method as shown in the embodiment shown in FIG. 4.
(2) the second selection item M2 is equal to the division method as shown in the embodiment shown in FIG. 6.
(3) the third selection item M3 is equal to a method of uniformly dividing the original data instead of subdividing the data. According to the present embodiment, the original data is divided into the first half and the latter half, which have the same size. The first half corresponds to the first subdata DA and the latter half corresponds to the second subdata DB.
(4) the fourth selection item M4 relates to a method of dividing the original data into a plurality of pieces of subdata having sizes different from each other, instead of subdividing the data. According to the embodiment, the original data is divided into a front portion corresponding to ¾ of the original data and a rear portion corresponding to ¼ of the original data. The front portion corresponds to the first subdata DA and the rear portion corresponds to the second subdata DB.
(5) the fifth selection item MS relates to a division method defined by a user. A user can input a division method on a text box TB on the setting screen MW according to predetermined rules. Further, a user can input the division method by using arbitrary rules. For example, rules (grammar) equivalent to various program languages can be employed.

When a user presses an OK button OKB on the setting screen MW, the division module 612 shown in FIG. 2 receives setting input through the setting screen MW. Then, the division module 612 divides the original data OD according to the division method designated through the setting screen MW. The decoding module 614 decodes the original data OD by a method which is inverse to the designated division method. Further, the division module 612 stores information on the division method in the division information DI shown in FIG. 3. In such a case, the decoding module 614 may determine a decoding method with reference to the division information DI.

As described above, since the division module 612 allows a user to determine the division method, the user can use a division method suitable for data to be protected. Further, the configuration which is necessary for data protection can be simplified.

Further, the division module 612 can receive the instructions from a user for the designation of the division method in an arbitrary manner without being limited to the method of using the setting screen MW. For example, the division module 612 can read a setting file prepared by a user. A user inputs information on designation of the division method in the setting file.

### D. Fourth Embodiment

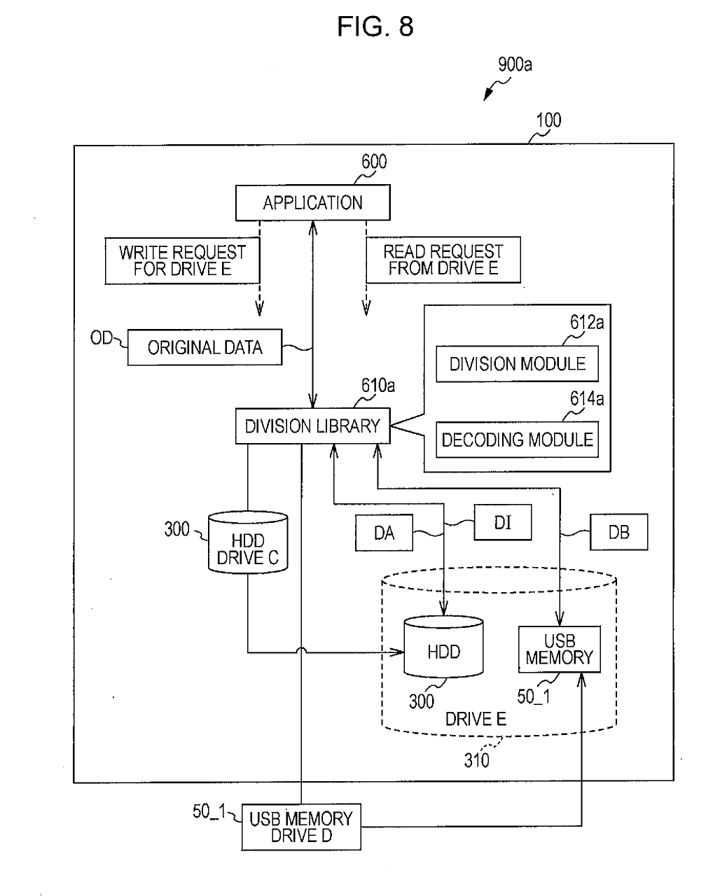

FIG. 8 is a block diagram showing functions of a data processing apparatus according to another embodiment of the invention. The present embodiment is substantially identical to the first embodiment shown in FIG. 2, except that the hard disk drive 300 and the USB memory 50_1 are regarded as one virtual memory area 310. The data processing system 900a according to the embodiment has a hardware configuration the same as that of the data processing system 900 of the first embodiment shown in FIG. 1. Further, the data processing system 900a uses a division library 610a instead of the division library 610 shown in FIG. 2. The division library 610a includes a division module 612a and a decoding module 614a. The division library 610a (modules 612a and 614a) regards the hard disk drive 300 and the USB memory 50_1 as one virtual memory area 310.

The data processing system 900a identifies one memory area based on a drive name. For example, in the embodiment shown in FIG. 8, the hard disk drive 300 is identified as a drive C and the USB memory 50_1 is identified as a drive D. Further, the virtual memory area 310 is identified as a drive E.

The division library 610a processes access requests (write request and read request) for the drive E. For example, when the application 600 has issued a write request of the original data OD for the drive E, the division module 612a processes the write request. In detail, similarly to the previous embodiments, the division module 612a divides the original data OD into the first subdata DA and the second subdata DB, stores the first subdata DA in the hard disk drive 300 and stores the second subdata DB in the USB memory 50_1.

Further, when the application 600 has issued a read request of the original data OD from the drive E, the decoding module 614a processes the read request. In detail, similarly to the previous embodiments, the decoding module 614a reads the first subdata DA from the hard disk drive 300 and read the second subdata DB from the USB memory 50_1. Further, the decoding module 614a decodes the original data OD by using the first subdata DA and the second subdata DB, and provides the application 600 with the resultant original data OD.

Further, an access request for the drive C (the hard disk drive 300) or the drive D (the USB memory 50_1) is processed by the operating system. In the write request for the drives C and D, data is stored instead of division.

According to the embodiment as described above, the application 600 issues a write request for the virtual drive E (the memory area 310), similarly to a case of writing data in a normal drive (memory area). Thus, a special write request is unnecessary and a configuration for the write request can be simplified. Further, data protection can be performed without storing a function dedicated for data division in the application 600. Further, the division library 610a may be commonly used for a plurality of applications.

Further, the division library 610a forms the virtual memory area according to the instructions of a user. For example, in the embodiment shown in FIG. 8, since the hard disk drive 300 and the USB memory 50_1 are designated by a user, the division library 610a forms one virtual memory area 310. In addition, the division library 610a may form one virtual memory area by using a plurality of predetermined memory areas (memory devices) without the instructions of a user.

The use of such a virtual memory area can be applied to the embodiments shown in FIGS. 1 to 7.

### E. Fifth Embodiment

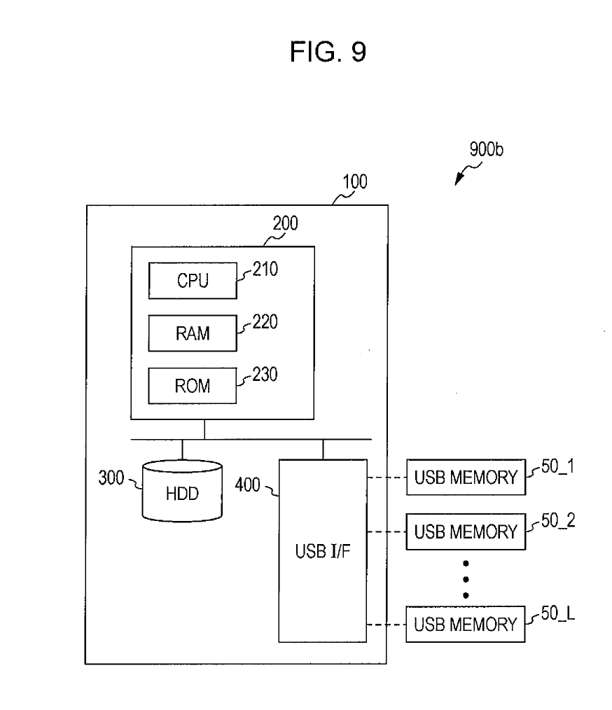

FIG. 9 is a block diagram showing a data processing system 900b according to another embodiment. The hardware configuration of the data processing system 900b is obtained by standardizing the hardware configuration of the embodiment shown in FIG. 1. The hardware configuration of the data processing apparatus 100 is substantially identical to that of the data processing apparatus 100 according to the embodiment shown in FIG. 1, except that L USB memories 50_1 to 50_L (L denotes an integer equal to or larger than 1) are connected to the USB interface 400.

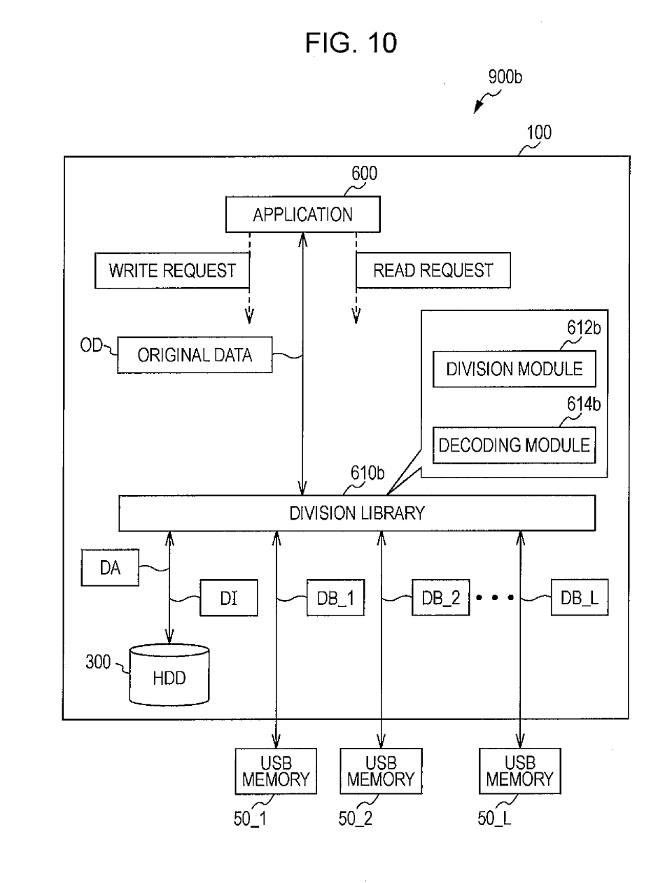

FIG. 10 is a block diagram showing functions of the data processing system 900b. The functions of the data processing system 900b are obtained by generalizing those of the embodiment shown in FIG. 2. A division library 610b (modules 612b and 614b) performs division and decoding of the original data OD, similarly to the division library 610 (modules 612 and 614) shown in FIG. 2.

The division module 612b divides the original data OD into N pieces of subdata DA and DB_1 to DB_L (N is 1+L, N denotes an integer equal to or larger than 2, and L denotes an integer equal to or larger than 1). The division module 612b stores the subdata DA in the hard disk drive 300. Further, the division module 612b stores the L pieces of subdata DB_1 to DB_L in the L USB memories 50_1 to 50_L, respectively. Preferably, in relation to the L pieces of subdata DB_1 to DB_L, the division module 612b stores the whole portion of one subdata in a USB memory, without simultaneously maintaining the whole portion of the one subdata in the data processing apparatus 100.

Further, the division module 612b stores the division information DI in the hard disk drive 300, similarly to the previous embodiments. The division information DI may include arbitrary information necessary for decoding the original data OD from the N pieces of subdata. For example, the division information DI may include information representing the storage positions of the N pieces of subdata. Further, the division information DI may include information representing a division method.

The decoding module 614b decodes the original data OD by using the N pieces of subdata. At this time, the decoding module 614b decodes the original data OD with reference to the division information DI.

According to the embodiment, it is preferable that L is equal to or larger than 2. In such a case, the L pieces of subdata DB_1 to DB_L are distributed and stored in the L USB memories 50_1 to 50_L. Thus, all of the L USB memories 50_1 to 50_L are connected to the data processing apparatus 100, so that the whole portion of the original data OD can be initially obtained. As a result, the original data OD can be reliably protected. For example, if L persons carry the L USB memories 50_1 to 50_L, the L persons must first be gathered before the original data OD can be decoded. Thus, the original data OD can be easily protected from unintended users.

Further, the embodiment may employ various methods as shown in FIGS. 4, 6 and 7 as a division method. For example, the N pieces of subdata can be generated using a plurality of segments obtained by subdividing the original data OD. In addition, the original data OD can be divided into the N pieces of subdata without using subdivision.

Preferably, the original data OD is divided such that the sizes of the L pieces of subdata DB_1 to DB_L are smaller than the size of the subdata DA stored in the fixed memory device (e.g., the hard disk drive 300) of the data processing apparatus 100. Thus, capacities of the L USB memories 50_1 to 50_L, which are necessary for storing the L pieces of subdata DB_l to DB_L, can be prevented from becoming excessively large. As a result, the configuration which is necessary for the data protection can be simplified.

Further, the embodiment can be applied to the previous embodiments shown in FIGS. 1 to 8.

### F. Sixth Embodiment

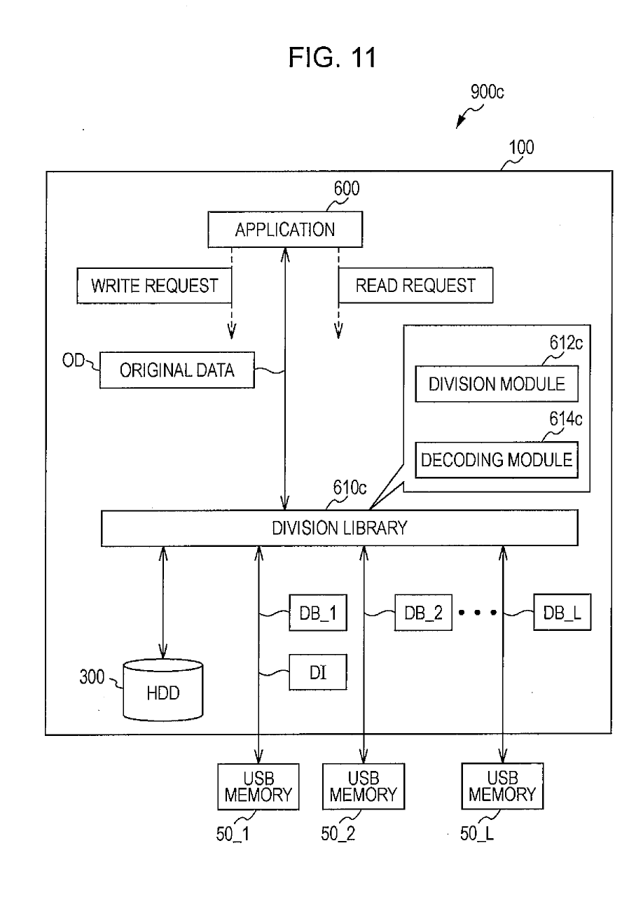

FIG. 11 is a block diagram showing functions of a data processing system 900c according to further another embodiment. The data processing system 900c is substantially identical to the data processing system 900b shown in FIG. 10, except that all pieces of subdata is stored in the USB memories. A division library 610c (modules 612c and 614c) performs division and decoding of the original data OD, similarly to the division library 610b (modules 612b and 614b) shown in FIG. 10. The hardware configuration of the data processing system 900c is substantially identical to that of the data processing system 900b according to the embodiment shown in FIG. 9.

The division module 612c divides the original data OD into L pieces of subdata DB_1 to DB_L (L denotes an integer equal to or larger than 2), and then stores each of the L pieces of subdata DB_1 to DB_L in the L USB memories 50_1 to 50_L.

Further, the division module 612c stores the division information DI in the one USB memory 50_1. A USB memory, which stores the division information DI, may be predetermined. Instead, a USB memory designated by a user may be used.

The decoding module 614c decodes the original data OD by using the L pieces of subdata.

As described above, all pieces of subdata can be stored in the USB memories. Thus, the original data OD can be decoded using a data processing apparatus different from the data processing apparatus 100 that has divided the original data OD.

Further, the embodiment can be applied to the previous embodiments shown in FIGS. 1 to 8. For example, when the embodiment is applied to the previous embodiment shown in FIG. 8, the division library 610c (modules 612c and 614c) shown in FIG. 11 forms one virtual memory area by using the L USB memories 50_1 to 50_L, instead of using the hard disk drive 300.

### G. Modifications

Since, among the elements in the previous embodiments, elements other than elements claimed in the appended independent claim are additional, the elements may be omitted. Further, the invention is not limited to the previous embodiments and various modifications can be made within the scope of the invention. For example, the following modifications can be made.

### Modification 1

Different to the previous embodiments, a plurality of pieces of subdata can be stored in one removable memory (e.g., the USB memory 50_1). In the case of using a plurality of removable memories similarly to the embodiments shown in FIGS. 9 to 11, a difference may occur in the total number of the subdata stored in each removable memory. However, when the original data is divided into N pieces of subdata, one to (N−1) pieces of different subdata can be respectively stored in L removable memories (L denotes an integer in a range of 1 to N). At this time, it is preferable that the whole portion of one subdata is stored in a removable memory without simultaneously maintaining the whole portion of one subdata in the data processing apparatus.

Further, different to the previous embodiments, a plurality of pieces of subdata can be stored in the fixed memory device (e.g., the hard disk drive 300) of the data processing apparatus 100. When P pieces of subdata is stored in the fixed memory device (P denotes an integer equal to or larger than 1), the total number of subdata stored in the L removable memories is (N−P) (i.e., less than N).

As described above, a plurality of pieces of subdata can be stored in one memory device (e.g., one removable memory or one fixed memory device). Thus, even if the subdata has been unintentionally copied from the one memory device to another recording apparatus, the possibility that all pieces of subdata is copied can be reduced. Thus, the original data can be reliability protected.

Further, in relation to the L removable memories, it is preferable that the original data is divided such that the total size of subdata stored in one removable memory is smaller than the total size of subdata stored in the fixed memory device of the data processing apparatus. Thus, the capacities of the L removable memories, which are necessary for storing the subdata, can be prevented from becoming excessively large.

### Modification 2

Different to the previous embodiments, various methods can be employed to divide the original data OD without being limited to the methods as described in FIGS. 4, 6 and 7.

For example, similarly to the embodiment shown in FIG. 4 or 6, the original data OD can be subdivided into K segments which is a higher number than the total number N of subdata and each segment can be allocated to one of the N pieces of the subdata according to predetermined rules. In such a case, the size of each segment can be arbitrarily determined. For example, the size of the segment may vary depending on the subdata to which the segment is allocated. Further, an arbitrary method can be used to allocate the segments.

Further, similarly to the third selection item M3 or the fourth selection item M4 shown in FIG. 7, the original data OD can be divided into subdata at a predetermined size ratio without being subdivided. The size ratio can be arbitrarily preset. For example, the original data OD can be divided into subdata corresponding to 9/10 of the original data OD and subdata corresponding to 1/10 of the original data OD.

Preferably, each bit of a bit sequence representing the original data OD can be allocated to one of the N pieces of subdata according to predetermined rules without changing the values. Thus, the data can be protected using the data processing apparatus having a low processing ability, so that the configuration which is necessary for the data protection can be simplified. Preferably, the order of bits in each subdata is identical to the order of bits in the original data OD. In this way, load for the data division process can be prevented from becoming excessively large.

### Modification 3

Different to the previous embodiments, the division information DI can be stored in the USB memory instead of the fixed memory device of the data processing apparatus 100. Further, the division information DI can be stored in both the fixed memory device and in the USB memory. Further, in the case of using a plurality of USB memories, the division information DI can be stored in each USB memory. In addition, the division information DI may be omitted. For example, the file names of each subdata include the file name of the original data OD, so the original data OD may correspond to a plurality of pieces of subdata. In general, the original data OD may correspond to a plurality of pieces of subdata in an arbitrary manner.

### Modification 4

Different to the previous embodiments, various interfaces can be used as the connection interface for performing connection to the removable memory, in addition to the USB (universal serial bus) interface. For example, an IrDA (infrared data association) interface or a Bluetooth interface can be employed. Further, a wired connection interface or a wireless connection interface can also be employed. In addition, a plurality of removable memories connected to other types of interfaces can be used. For example, the subdata can be stored in the USB memory and a memory connected through the IrDA interface.

In all cases, various memory devices temporarily connected to the connection interface can be employed as the removable memory.

### Modification 5

Different to the previous embodiments, various memory devices can be employed as the fixed memory device which is fixed to the data processing apparatus 100 to store the subdata, in addition to the hard disk drive 300. For example, a semiconductor memory such as a flash memory can be employed. Further, in the case of storing a plurality of pieces of subdata in the data processing apparatus 100, the plurality of pieces of subdata can be distributed and stored in a plurality of fixed memory devices. In such a case, various memory devices, such as a semiconductor memory including a flash memory, and a hard disk drive, can be employed as the removable memory.

In all cases, it is preferable that a non-volatile memory device (e.g., a flash memory and a hard disk drive) is employed as the memory device for storing the subdata. Thus, data can be maintained for a long period of time.

### Modification 6

Different to the previous embodiments, the configuration of the system partially realized by hardware can be replaced with software. In contrast, the configuration of the system partially or completely realized by software can be replaced with hardware. For example, functions of the division module 612 shown in FIG. 2 can be realized by a dedicated hardware circuit.

Further, when the invention is partially or completely realized by software, the software (computer program) can be provided in the form of a computer-readable recording medium. In the invention, the computer-readable recording medium includes various internal memory devices of a computer such as RAMs and ROMs, and external memory devices (e.g., a hard disk) fixed to the computer, in addition to a portable recording medium such as a flexible disk and a CD-ROM.

The entire disclosure of Japanese Patent Application No. 2008-240696, filed Sep. 19, 2008 is expressly incorporated by reference herein.

What is claimed is:

1. A data processing apparatus comprising:
a connection interface that performs connection to removable memories; and
a dividing unit that divides original data into N pieces of subdata (N denotes an integer of 2 or more),
wherein the dividing unit stores one to (N−1) pieces of different subdata respectively in L removable memories (L denotes an integer in a range of 1 to N), which are connected to the connection interface.

2. The data processing apparatus according to claim 1, further comprising a memory device fixed to the data processing apparatus,
wherein a total number of the subdata stored in the L removable memories is smaller than N,
and the dividing unit stores at least one piece of subdata, which corresponds to a remainder obtained by subtracting the subdata stored in the L removable memories from the N pieces of subdata, in the memory device, and divides the original data such that a total size of the subdata stored in one removable memory is smaller than a total size of the subdata stored in the memory device, in relation to the L removable memories.

3. The data processing apparatus according to claim 1, wherein, in relation to the subdata stored in the removable memories, the dividing unit stores a whole portion of one subdata in the removable memory, without simultaneously maintaining the whole portion of the one subdata in the data processing apparatus.

4. The data processing apparatus according to claim 1, wherein the dividing unit allows a user to determine a data division method.

5. The data processing apparatus according to claim 1, wherein the dividing unit performs division and storage of the original data in response to a write request for the original data.

6. The data processing apparatus according to claim 5, wherein, in relation to a plurality of memory areas used for storing the N pieces of subdata, the dividing unit regards a plurality of memory areas including the L removable memories as one virtual memory area,
and the original data is written on the one virtual memory area in response to the write request for the original data.

7. The data processing apparatus according to claim 1, further comprising a decoding unit that decodes the original data by using the N pieces of subdata including the subdata stored in the removable memories.

8. A data processing method comprising:
dividing original data into N pieces of subdata (N denotes an integer of 2 or more); and
storing one to (N−1) pieces of different subdata respectively in L removable memories (L denotes an integer in a range of 1 to N).

9. A computer-readable recording medium for a recording computer program that prompts a computer to execute functions of dividing original data into N pieces of subdata (N denotes an integer of 2 or more), and storing one to (N−1) pieces of different subdata respectively in L removable memories (L denotes an integer in a range of 1 to N).
